(19) United States
(12) Patent Application Publication
(10) Pub. No.: US 2010/0075271 A1
(43) Pub. Date: Mar. 25, 2010

(54) ORTHODONTIC EYELET WITH CRIMPABLE PORTIONS AND RELATED METHODS

(75) Inventors: Jefferson Sabilla, Ontario, CA (US); Pinki Ghantiwala, Walnut, CA (US)

Correspondence Address: WOOD, HERRON & EVANS, LLP, 2700 CAREW TOWER, 441 VINE STREET, CINCINNATI, OH, 45202, US

(73) Assignee: ORMCO CORPORATION, Orange, CA (US)

(21) Appl. No.: 12/443,858

(22) PCT Filed: Oct. 10, 2007
(86) PCT No.: PCT/US07/80877

§ 371 Date: Nov. 19, 2009

Related U.S. Application Data
(60) Provisional application No. 60/850,624, filed on Oct. 10, 2006.

(51) Int. Cl. A61C 7/00

(52) U.S. Cl. 433/18

(57) ABSTRACT

An orthodontic eyelet (12) includes an engaging portion (20) configured for coupling onto an orthodontic implant (16). A crimpable portion (18) is coupled to the engaging portion (20) and has first and second configurations different from one another. In the second configuration the orthodontic eyelet (12) permits coupling to an orthodontic corrective device (14). The second configuration may be such that it hinders rotation of the orthodontic eyelet (12) relative to the orthodontic implant (16). The second configuration may additionally or alternatively permit adjustment of a position of the corrective device (14) to which the orthodontic eyelet (12) is coupled relative to the orthodontic eyelet. The engaging portion (20) may include an opening defining a first shape that substantially matches a second shape corresponding to the orthodontic implant (16). In this regard, the first shape may cooperate with the second shape to move the orthodontic eyelet (12) and the orthodontic implant (16) into locking engagement with one another.

### PRIORITY CLAIM

This application claims the benefit of U.S. Provisional Patent Application Ser. No. 60/850,624, filed Oct. 10, 2006 and entitled “Orthodontic Devices, Implants and Related Apparatus,” the disclosures of which are expressly incorporated by reference herein in their entirety.

### TECHNICAL FIELD

This invention generally relates to orthodontic systems and, more particularly, to eyelets at the end of orthodontic corrective devices for coupling to orthodontic implants.

### BACKGROUND

Orthodontic devices address different types of problems in a patient's mouth, such as improving a patient's occlusion. Known orthodontic devices include implants such as screws, which are fixed to a structure in the patient's mouth. Corrective devices such as wires or springs are then coupled to the implants such that a corrective force can be applied to teeth.

Known implants may have a round screw head or a bracket shaped head. Auxiliary attachments may be secured to these implants by placing a round eyelet of the corrective device (e.g., like one found on a coil spring) over the head of the implant and an undercut or neck beneath the screw head is relied upon to retain the eyelet in place. Alternatively, attachments are ligated onto the head of the implant to secure the corrective device thereto, which can be cumbersome.

Accordingly, orthodontic devices of the type described above may require considerable time and skill in order to secure a position of the corrective device relative to the implant.

### SUMMARY

In one embodiment, an orthodontic eyelet includes an engaging portion configured for coupling onto an orthodontic implant. A crimpable portion is coupled to the engaging portion and has first and second configurations different from one another. In the first configuration, the crimpable portion is capable of receiving a wire or other member of an orthodontic corrective device. In the second configuration the orthodontic eyelet permits coupling to an orthodontic corrective device. The second configuration may be such that it hinders rotation of the orthodontic eyelet relative to the orthodontic implant. The second configuration may additionally or alternatively permit adjustment of a position of the corrective device to which the orthodontic eyelet is coupled relative to the orthodontic eyelet.

The engaging portion may include an opening defining a first shape that substantially matches a second shape corresponding to the orthodontic implant. In this regard, the first shape may cooperate with the second shape to move the orthodontic eyelet and the orthodontic implant into locking engagement with one another. The first shape may for example be polygonal, such as triangular, or it may be elliptical.

In a specific embodiment, the crimpable portion includes a leg configured to be received within an aperture of the orthodontic implant to move the orthodontic eyelet and the orthodontic implant into locking engagement with one another. This may restrict rotational and/or axial movement of the orthodontic eyelet relative to the orthodontic implant.

In another embodiment, an orthodontic assembly includes an orthodontic implant and an orthodontic eyelet. The eyelet includes an engaging portion coupled to the orthodontic implant as well as a crimpable portion having first and second configurations different from one another. In the second configuration, the orthodontic eyelet permits coupling to an orthodontic corrective device.

In another embodiment, an orthodontic system includes an orthodontic corrective device, an orthodontic implant, and an orthodontic eyelet. The eyelet includes an engaging portion configured for coupling onto the orthodontic implant and a crimpable portion having first and second configurations. In the first configuration the orthodontic eyelet is not coupled to the orthodontic corrective device while in the second configuration the orthodontic eyelet is coupled to the orthodontic corrective device.

In yet another embodiment, a method of securing an orthodontic corrective device to an orthodontic implant includes crimping a portion of an orthodontic eyelet to move the orthodontic eyelet into locking engagement with the orthodontic corrective device. An engaging portion of the orthodontic eyelet is moved from a first orientation in which the orthodontic eyelet is not coupled to the orthodontic implant to a second orientation in which the orthodontic eyelet is coupled to the orthodontic implant. The engaging portion is rotated relative to the orthodontic implant to bring the corrective device into locking engagement with the orthodontic implant.

In yet another embodiment, a method of securing an orthodontic corrective device to an orthodontic implant includes the steps described above but does not include rotating the engaging portion of the eyelet relative to the orthodontic implant.

### BRIEF DESCRIPTION OF THE DRAWINGS

Various additional features and aspects will become readily apparent to those of ordinary skill in the art from the following description of illustrative embodiments of the invention and from the drawings in which:

FIG. 1A is a perspective view of an embodiment of an orthodontic eyelet and a corrective device;

FIG. 1B is a perspective view of the orthodontic eyelet and corrective device of FIG. 1A in a coupled configuration;

FIG. 1C is a perspective view of the orthodontic eyelet and corrective device of FIGS. 1A-1B coupled to an orthodontic implant, shown in phantom;

FIG. 2A is a perspective view of another embodiment of an orthodontic eyelet and an orthodontic implant;

FIG. 2B is an elevation view of the orthodontic eyelet and orthodontic implant of FIG. 2A;

FIG. 2C is a cross-sectional view taken along line 2C-2C of FIG. 2A;

FIG. 3A is a perspective view of another embodiment of an orthodontic eyelet and an orthodontic implant;

FIG. 3B is a perspective view of the orthodontic eyelet and orthodontic implant of FIG. 3A with the orthodontic eyelet having an orientation different from that shown in FIG. 3A; and

FIG. 3C is a perspective view of the orthodontic eyelet and orthodontic implant of FIGS. 3A-3B being in locking engagement with one another.

### DETAILED DESCRIPTION

Although the invention will be described next in connection with certain embodiments, the invention is not limited to practice in any one specific type of orthodontic system. The description of the embodiments of the invention is intended to cover all alternatives, modifications, and equivalent arrangements as may be included within the spirit and scope of the invention as defined by the appended claims. In particular, those skilled in the art will recognize that the components of the embodiments of the invention described herein could be configured in multiple different ways.

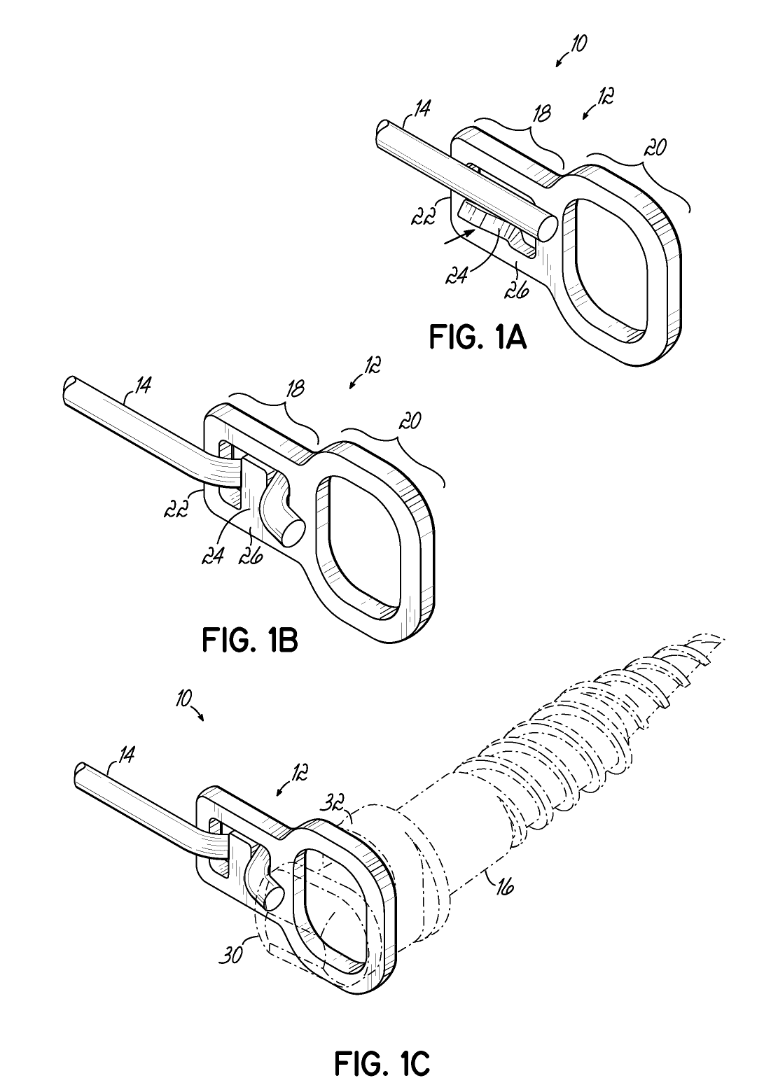

Referring now to the drawings, and more particularly to FIGS. 1A-1C, an orthodontic system 10 includes an orthodontic eyelet 12 that is configured to facilitate coupling between an orthodontic corrective device and an orthodontic implant. In the figures, the corrective device is in the form of a wire 14, although this is only for illustrative purposes since the corrective device may alternatively take other forms, such as springs and the like. Likewise, the figures depict an orthodontic implant in the form of a screw 16, shown in phantom, although other forms of implants are similarly contemplated. Suitable orthodontic implants are disclosed in PCT International Application No. ______, filed Oct. 10, 2007, entitled “Orthodontic Implants,” which is expressly incorporated by reference herein in its entirety.

With particular reference to FIG. 1A, the eyelet 12 includes a crimpable portion 18 and an engaging portion 20. The crimpable portion 18 permits coupling of the eyelet 12 to the wire 14, while the engaging portion 20 permits coupling of the eyelet 12 to the screw 16. The crimpable portion 18 is defined by a generally rectangular frame 22, oriented such as to define a plane, and a tab 24. The tab 24 is coupled a frame member 26 of the frame 22, and projects so as to define an acute angle relative to the plane defined by frame 22.

The angular orientation of the tab 24 relative to the frame 22 defines a first configuration of the crimpable portion 18 in which the eyelet 12 is not coupled to the wire 14. In this configuration, the angular orientation of the tab 24 permits receipt of a portion of the wire 14 between the tab 24 and the frame 22. In this regard, the angle between tab 24 and frame 22 defines the thickness of the archwire 14 that can be received by crimpable portion 18.

With particular reference to FIG. 1B, the tab 24 is bendable about a region of coupling thereof with frame member 26, thereby permitting crimping of the crimpable portion 18 with wire 14. More particularly, bending of the tab 24 deforms the crimpable portion 18 and/or wire 14 such that at least a portion of the wire 14 is forced onto one side of the frame 22, while other portions thereof are forced onto the opposite side of frame 22. This deformation of the archwire 14, accordingly, brings the archwire 14 into locking engagement with the eyelet 12. While in this embodiment crimping deforms the crimpable portion 18 and the wire 14, those of ordinary skill in the art will readily appreciate that crimping may alternatively deform only crimpable portion 18 around wire 14, while leaving the shape of wire 14 substantially intact.

With particular reference to FIGS. 1B-1C, and as noted above, the eyelet 12 includes an engaging portion 20 that permits coupling of the eyelet 12 with the screw 16, shown in phantom. More particularly, the engaging portion 20 has an elliptical shape defined by four segments oriented generally coplanar with the crimpable portion 18. In this regard, the four segments are sized such as to permit engagement over and around a head 30 of the screw 16, to thereby couple the eyelet 12 around a neck 32 of the screw 16. While engaging portion 20 is depicted being coplanar with crimpable portion 18, those of ordinary skill in the art will readily appreciate that other non-coplanar configurations are possible. Likewise, while the engaging portion 20 is depicted having a generally elliptical shape, other shapes are contemplated, such as polygonal (e.g., triangular) or other shapes including planar and/or arcuate surfaces.

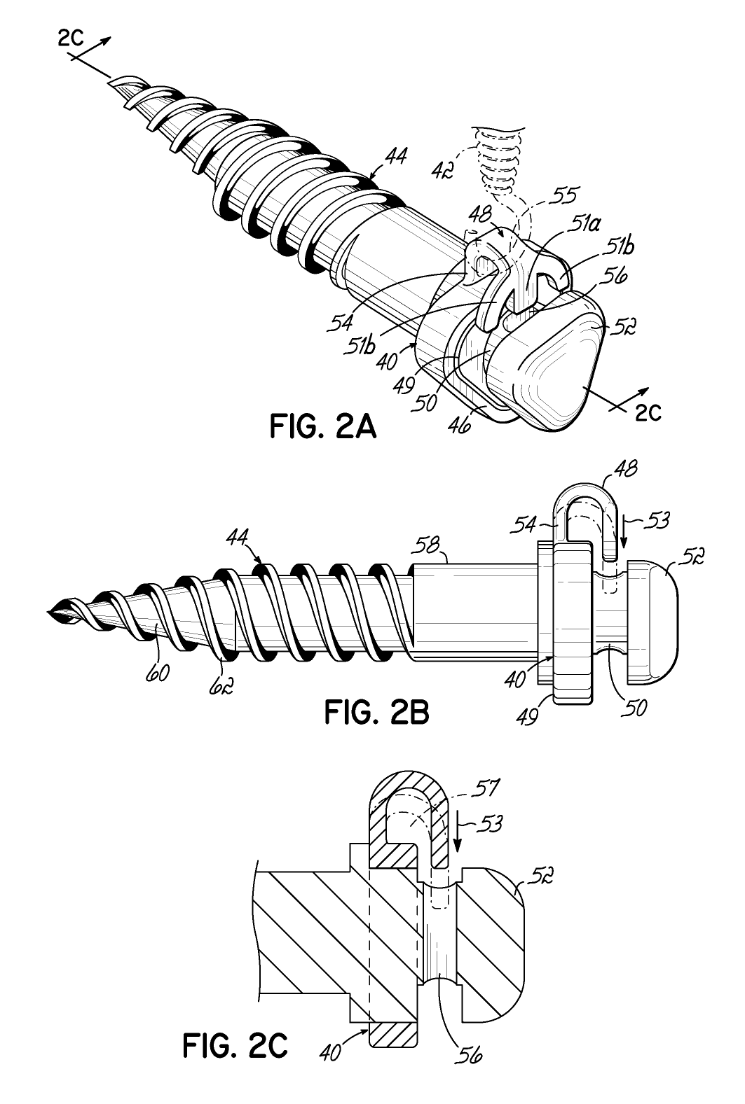

With reference to FIGS. 2A-2C, another embodiment of an orthodontic eyelet 40 permits coupling of an orthodontic corrective device in the form of a spring 42 (in phantom) to an orthodontic implant in the form of a screw 44. The eyelet 40 includes an engaging portion 46 having a generally triangular opening and a crimpable portion 48. The triangular opening of the engaging portion 46 substantially matches a triangular base portion 49 of a neck disposed adjacent a head 52 of the screw 44. An apple core shaped transition portion 50 of the neck facilitates travel of the eyelet 40 between head 52 and triangular base portion 49. Accordingly, when the engaging portion 46 is coupled with the triangular base portion 49, the eyelet 40 is in locking engagement with the screw 44, thereby preventing rotation of the eyelet 40 relative to the screw 44.

Cooperating locking features of the crimpable portion 48 and the neck further prevent rotation of the eyelet 40 relative to the screw 44. More particularly, the crimpable portion 48 of the eyelet 40 includes a center leg 51a and two outer legs 51b, all coupled to the engaging portion 46 via arm 54. The legs 51a, 51b are movable such that, when crimpable portion 48 is crimped, the legs 51a, 51b engage the transition portion 50 of the neck of screw 44. Arrow 53 (FIGS. 2B-2C) shows the general direction of motion of the legs 51a, 51b during crimping of crimpable portion 48. In this regard, when crimped (the position shown in phantom in FIGS. 2B-2C) the outer legs 51b wrap around transition portion 50, while center leg 51a is received within an aperture 56 of the neck 50. The legs 51a, 51b thus cooperate with the transition portion 50 and aperture 56 to further prevent rotation of the eyelet 40 relative to the screw 44. Similarly, the crimped position of legs 51a, 51b prevents or at least hinders axial movement (i.e., along the longitudinal axis of the screw 44) of eyelet 40 relative to screw 44.

Coupling of the spring 42 to eyelet 40 is facilitated by engagement of a portion 55 of the spring within a closed loop 57 of the eyelet 40 defined by crimping movement of legs 51a, 51b toward screw 44. This engagement couples the spring 42 to eyelet 40 while permitting adjustment of the position of the spring 42 relative to the eyelet 40. More particularly, the spring 42 may be decoupled from the eyelet 40, its length or other characteristic adjusted, and spring 42 reengaged with the closed loop 57 of eyelet 40. Accordingly, this system permits adjustment of the position of the spring 42 relative to the eyelet 40.

With continued reference to FIGS. 2A-2C, the head 52 of screw 44 is shown having a triangular shape, although this is merely illustrative rather than intended to be limiting. In this regard, the size and/or shape of the head 52 may be different from what is shown, so long as it permits travel of the engaging portion 46 over the head and engagement with the neck of screw 44. Likewise, the screw 44 is shown as a having a cylindrical portion 58, a tapered shank 60 connected to the cylindrical portion 58, and threads 62 disposed over the shank 60. Those of ordinary skill will readily appreciate that other types of implants may be alternatively used.

While the embodiment of FIGS. 2A-2C depict an orthodontic system including a corrective device in the form of a spring 42, it is contemplated that other corrective devices such as wires may also be used in conjunction with the components described in connection with such embodiment.

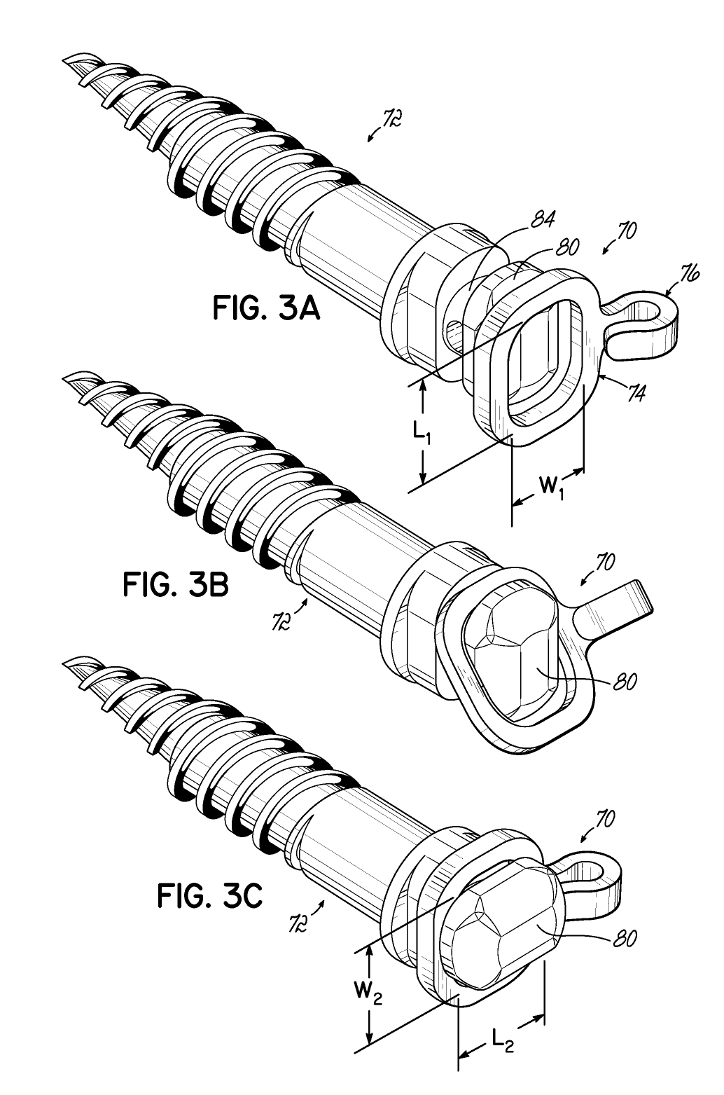

With reference to FIGS. 3A-3C, an alternative embodiment of an orthodontic eyelet 70 is shown during coupling with an orthodontic implant in the form of a screw 72. The eyelet 70 includes an engaging portion 74 that facilitates coupling with the screw 72, and a crimpable portion 76 that permits coupling with a corrective device (not shown). The crimpable portion 76 is generally U-shaped and is bendable to define a closed loop (not shown) through which the corrective device may extend in a fashion similar to that corresponding to the embodiment of FIGS. 2A-2C.

The engaging portion 74 has a generally elliptical shape having a first dimension “L₁” along a major axis thereof that is greater than a second dimension “W₁” along a minor axis. A head 80 of the screw 72 also has a generally elliptical shape, defining a first dimension L₂ along a major axis thereof that is greater than a second dimension W₂ along a minor axis. In this embodiment, the shapes of the engaging portion 74 and head 80 are similar such that the eyelet 70 (i.e., the engaging portion 74 thereof) may travel over the head 80 and subsequently engage a neck 84 of the screw 72, thereby coupling the eyelet 70 to the screw 72.

More particularly, the shapes of the engaging portion 74 and head 80 are chosen such that, for example, the eyelet 70 may be moved as shown into engagement with screw 44. In this regard, the eyelet 70 may be turned from a first orientation, as shown in FIG. 3A, in which the engaging portion 74 is generally parallel to the head 80, to a second orientation, as shown in FIG. 3B, in which the eyelet 70 is turned at an acute angle relative to the head 80. Accordingly, travel of the engaging portion 74 over the head 80 is facilitated.

The shapes of the engaging portion 74 and head 80 are also chosen such that rotation of the eyelet 70 relative to the head 80 of screw 72 moves eyelet 70 and screw 72 into locking engagement with one another. In this regard, such locking engagement is brought about by rotating the eyelet 70 (or at least the engaging portion 74 thereof) from a first orientation (FIG. 3B) to a second orientation (FIG. 3C) that is different from the first orientation. More specifically, in the first orientation (FIG. 3B), the eyelet 70 is positioned such that its first dimension L₁ is generally parallel to the first dimension L₂ of the head 80. In the second orientation (FIG. 3C), the eyelet 70 is positioned such that its first dimension L₁ is generally orthogonal or at least transverse to the first dimension L₂ of the head 80. Accordingly, this locking engagement defines a twist lock between the eyelet 70 and the screw 72, thereby preventing axial movement of eyelet 70 relative to screw 72. This locking engagement also fixes a position of the corrective device (not shown) to which the eyelet 70 is attached relative to screw 72.

While the present invention has been illustrated by a description of various preferred embodiments and while these embodiments have been described in some detail, it is not the intention of the Applicants to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with the preferred methods of practicing the present invention as currently known. However, the invention itself should only be defined by the appended claims.

What is claimed is:

1. An orthodontic eyelet comprising:
an engaging portion configured for coupling onto an orthodontic implant; and
a crimpable portion adjacent said engaging portion and having a first configuration and a second configuration different from said first configuration and in which said orthodontic eyelet permits coupling of said orthodontic eyelet to an orthodontic corrective device.

2. The orthodontic eyelet of claim 1, wherein said second configuration hinders rotation of said orthodontic eyelet relative to the orthodontic implant.

3. The orthodontic eyelet of claim 1, wherein said second configuration permits adjustment of a position of the corrective device to which said orthodontic eyelet is coupled relative to said orthodontic eyelet.

4. The orthodontic eyelet of claim 1, wherein said engaging portion includes an opening defining a first shape substantially matching a second shape of the orthodontic implant.

5. The orthodontic eyelet of claim 4, wherein said first shape is configured to cooperate with the second shape to lockingly engage said orthodontic eyelet and the orthodontic implant to one another.

6. The orthodontic eyelet of claim 4, wherein said first shape is polygonal.

7. The orthodontic eyelet of claim 6, wherein said first shape is triangular.

8. The orthodontic eyelet of claim 4, wherein said first shape is elliptical.

9. The orthodontic eyelet of claim 1, wherein said crimpable portion includes a leg configured to be received within an aperture of the orthodontic implant to thereby lockingly engage said orthodontic eyelet and the orthodontic implant to one another.

10. The orthodontic eyelet of claim 9, wherein receipt of said leg within the aperture of the orthodontic implant restricts at least one of rotational movement and axial movement of the orthodontic eyelet relative to the orthodontic implant.

11. An orthodontic assembly comprising:
an orthodontic implant; and
an orthodontic eyelet including an engaging portion coupled to said orthodontic implant and a crimpable portion having a first configuration and a second configuration different from said first configuration and in which said orthodontic eyelet permits coupling to an orthodontic corrective device.

12. The orthodontic assembly of claim 11, wherein said second configuration hinders rotation of said orthodontic eyelet relative to said orthodontic implant.

13. The orthodontic assembly of claim 11, wherein said second configuration permits adjustment of a position of the corrective device to which said orthodontic eyelet is coupled relative to said orthodontic eyelet.

14. The orthodontic assembly of claim 11, wherein said engaging portion includes an opening defining a first shape and said orthodontic implant includes a neck defining a second shape, said first and second shapes substantially matching one another.

15. The orthodontic assembly of claim 14, wherein coupling of said first shape with said second shape brings said orthodontic eyelet and said orthodontic implant into locking engagement with one another.

16. The orthodontic assembly of claim 14, wherein said first shape is polygonal.

17. The orthodontic assembly of claim 16, wherein said first shape is triangular.

18. The orthodontic assembly of claim 14, wherein said first shape is elliptical.

19. The orthodontic assembly of claim 11, wherein said crimpable portion includes a leg and said orthodontic implant includes an aperture, said leg and said aperture cooperating with one another to bring said orthodontic eyelet and said orthodontic implant into locking engagement with one another.

20. An orthodontic system comprising:
an orthodontic corrective device;
an orthodontic implant; and
an orthodontic eyelet including an engaging portion configured for coupling onto said orthodontic implant and a crimpable portion having a first configuration in which said orthodontic eyelet is not coupled to said orthodontic corrective device and a second configuration in which said orthodontic eyelet is coupled to said orthodontic corrective device.

21. The orthodontic system of claim 20, wherein said corrective device is one a group consisting of springs and wires.

22. The orthodontic system of claim 20, wherein said second configuration hinders rotation of said orthodontic eyelet relative to said orthodontic implant.

23. The orthodontic system of claim 20, wherein said second configuration permits adjustment of a position of said corrective device relative to said orthodontic eyelet.

24. A method of securing an orthodontic corrective device to an orthodontic implant, comprising:
crimping a portion of an orthodontic eyelet to bring the orthodontic eyelet into locking engagement with the orthodontic corrective device;
moving an engaging portion of the orthodontic eyelet from a first orientation in which the orthodontic eyelet is not coupled to the orthodontic implant to a second orientation in which the orthodontic eyelet is coupled to the orthodontic implant; and
rotating the engaging portion relative to the orthodontic implant to move the corrective device into locking engagement with the orthodontic implant.

25. A method of securing an orthodontic corrective device to an orthodontic implant, comprising:
crimping a portion of an orthodontic eyelet to bring the orthodontic eyelet into locking engagement with the orthodontic corrective device; and
moving an engaging portion of the orthodontic eyelet from a first orientation in which the orthodontic eyelet is not coupled to the orthodontic implant to a second orientation in which the orthodontic eyelet is coupled to the orthodontic implant.
